(19) United States
(12) Patent Application Publication
(10) Pub. No.: US 2018/0307352 A1
(43) Pub. Date: Oct. 25, 2018

(54) SYSTEMS AND METHODS FOR GENERATING CUSTOM VIEWS OF VIDEOS

(71) Applicant: GoPro, Inc., San Mateo, CA (US)

(72) Inventor: Daryl Stimm, Encinitas, CA (US)

(21) Appl. No.: 15/497,035

(22) Filed: Apr. 25, 2017

(51) Int. Cl. G06F 3/048; H04N 21/4402; H04N 21/4147

(52) U.S. Cl. CPC G06F 3/048; H04N 21/4147; H04N 21/440263

(57) ABSTRACT

Spherical video content may be presented on a display. Interaction information may be received during presentation of the spherical content on the display. Interaction information may indicate a user's viewing selections of the spherical video content, including viewing directions for the spherical video content. Display field of view may be determined based on the viewing directions. The display fields of view may define extents of the visual content viewable as a function of progress through the spherical video content. User input to record a custom view of the spherical video content may be received and a playback sequence for the spherical video content may be generated. The playback sequence may mirror at least a portion of the presentation of the spherical video content on the display.

### FIELD

This disclosure relates to generating custom views of videos based on user's viewing selections of the videos.

### BACKGROUND

A video may include greater visual capture of one or more scenes/objects/activities than desired to be viewed (e.g., over-capture). Manually editing the video to focus on the desired portions of the visual capture may be difficult and time consuming.

### SUMMARY

This disclosure relates to generating custom views of videos. Video information defining spherical video content may be accessed. The spherical video content may have a progress length. The spherical video content may define visual content viewable from a point of view as a function of progress through the spherical video content. The spherical video content may be presented on a display. Interaction information may be received during the presentation of the spherical content on the display. The interaction information may indicate a user's viewing selections of the spherical video content. The user's viewing selections may include viewing directions for the spherical video content selected by the user as the function of progress through the spherical video content. Display field of view may be determined based on the viewing directions. The display fields of view may define extents of the visual content viewable from the point of view as the function of progress through the spherical video content.

User input to record a custom view of the spherical video content may be received. Responsive to receiving the user input to record the custom view of the spherical video content, a playback sequence for the spherical video content may be generated based on at least a portion of the interaction information. A playback sequence may identify one or more of (1) different points in the progress length to be displayed during playback, (2) an order in which the identified points are displayed during playback, (3) the extents of the visual content to be displayed at the identified points, and/or other information about how the spherical video content is to be displayed during playback. The playback sequence may mirror at least a portion of the presentation of the spherical video content on the display. A playback sequence may include one or more files containing descriptions/instructions regarding how to present the spherical video content during a subsequent playback such that the subsequent presentation mirrors at least a portion of the presentation of the spherical video content on the display. A playback sequence may include one or more video content that mirrors at least a portion of the spherical visual content presented on the display.

A system that generates custom views of videos may include one or more of electronic storage, display, processor, and/or other components. The display may be configured to present video content and/or other information. In some implementations, the display may include a touchscreen display configured to receive user input indicating the user's viewing selections of the video content. The user's viewing selections may be determined based on the user input received via the touchscreen display. The touchscreen display may generate output signals indicating a location of the user's engagements with the touchscreen display. In some implementations, the display may include a motion sensor configured to generate output signals conveying motion information related to a motion of the display. In some implementations, the motion of the display may include an orientation of the display, and the user's viewing selections of the video content may be determined based on the orientation of the display.

The electronic storage may store video information defining video content, and/or other information. Video content may refer to media content that may be consumed as one or more videos. Video content may include one or more videos stored in one or more formats/container, and/or other video content. Video content may have a progress length. The video content may define visual content viewable as a function of progress through the video content. In some implementations, video content may include one or more of spherical video content, virtual reality content, and/or other video content. Spherical video content may define visual content viewable from a point of view as a function of progress through the spherical video content.

The processor(s) may be configured by machine-readable instructions. Executing the machine-readable instructions may cause the processor(s) to facilitate generating custom views of videos. The machine-readable instructions may include one or more computer program components. The computer program components may include one or more of an access component, a presentation component, an interaction component, a viewing component, a playback sequence component, and/or other computer program components. In some implementations, the computer program components may include a visual effects component.

The access component may be configured to access the video information defining one or more video content and/or other information. The access component may access video information from one or more storage locations. The access component may be configured to access video information defining one or more video content during acquisition of the video information and/or after acquisition of the video information by one or more image sensors.

The presentation component may be configured to effectuate presentation of the video content on the display. For example, the presentation component may effectuate presentation of spherical video content on the display. In some implementations, the presentation component may be configured to effectuate presentation of one or more user interfaces on the display. A user interface may include a record field and/or other fields.

The interaction component may be configured to receive interaction information during the presentation of the video content on the display. For example, the interaction component may receive interaction information during the presentation of spherical video content on the display. The interaction information may indicate a user's viewing selections of the video content and/or other information. The user's viewing selections may include viewing directions for the video content selected by the user as the function of progress through the video content, and/or other information. In some implementations, the user's viewing selections may include viewing zooms for the video content selected by the user as the function of progress through the video content. In some implementations, the user's viewing selections may include visual effects for the video content selected by the user as the function of progress through the video content.

In some implementations, the interaction information may be determined based on the location of the user's engagements with the touchscreen display, and/or other information. In some implementations, the interaction information may be determined based on the motion of the display, and/or other information.

The interaction component may be configured to receive user input to record a custom view of the video content. For example, the interaction component may receive user input to record a custom view of spherical video content. In some implementations, the user input to record the custom view of the video content may be received based on the user's interaction with the record field within the user interface.

The viewing component may be configured to determine display fields of view based on the viewing directions and/or other information. The display fields of view may define viewable extents of visual content within the video content. In some implementations, the display fields of view may be further determined based on the viewing zooms and/or other information.

For the spherical video content, the display fields of view may define extents of the visual content viewable from the point of view as the function of progress through the spherical video content. For example, the display fields of view may define a first extent of the visual content at a first point in the progress length and a second extent of the visual content at a second point in the progress length. The presentation of the spherical video content on the display may include presentation of the extents of the visual content on the display at different points in the progress length such that the presentation of the spherical video content on the display includes presentation of the first extent at the first point prior to presentation of the second extent at the second point.

The visual effects component may be configured to apply one or more visual effects to the video content. A visual effect may refer to a change in presentation of the video content on a display. A visual effect may change the presentation of the video content for a video frame, for multiple frames, for a point in time, and/or for a duration of time. In some implementations, a visual effect may include one or more changes in perceived speed at which the video content is presented during playback. In some implementations, a visual effect may include one or more visual transformation of the video content. In some implementations, the visual effects may include a change in a projection for the video content and/or other visual effects. In some implementations, the visual effects may include one or more preset changes in the video content and/or other visual effects. In some implementations, the visual effects component may select one or more visual effects based on a user selection. In some implementations, the visual effects component may select one or more visual effects randomly from a list of visual effects.

The playback sequence component may be configured to generate one or more playback sequences for the video content based on at least a portion of the interaction information and/or other information. The playback sequence component may generate one or more playback sequences responsive to reception of the user input to record the custom view of the video content.

A playback sequence may include one or more files containing descriptions/instructions regarding how to present the video content during a subsequent playback such that the subsequent presentation mirrors at least a portion of the presentation of the video content on the display. A playback sequence may include one or more video content that mirrors at least a portion of the visual content presented on the display. A playback sequence may mirroring at least a portion of the presentation of the video content on the display such that the playback sequence identifies one or more of: (1) at least some of the different points in the progress length to be displayed during playback—some of the different points may include the first point and the second point; (2) an order in which the identified points are displayed during playback—the order may include presentation of the first point prior to presentation of the second point; (3) the extents of the visual content to be displayed at the identified points during playback—the extents may include the first extent at the first point and the second extent at the second point, and/or other information about how the video content is to be displayed during playback.

In some implementations, generating a playback sequence for video content may include encoding one or more video content based on at least the portion of the interaction information. In some implementations, generating a playback sequence for spherical video content may include encoding one or more non-spherical video content based on at least the portion of the interaction information. The non-spherical video content may mirroring at least the portion of the presentation of the spherical video content on the display. In some implementations, generating a playback sequence for video content may include generating one or more files containing descriptions to change the presentation of the video content based on least the portion of the interaction information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that generates custom views of videos.

FIG. 2 illustrates a method for generating custom views of videos.

FIG. 3 illustrates an example spherical video content.

FIGS. 4A-4B illustrate example extents of spherical video content.

FIG. 5 illustrates example viewing directions selected by a user.

FIG. 6 illustrates an example mobile device for generating custom views of videos.

FIG. 7 illustrates an example mobile device for generating custom views of spherical videos.

### DETAILED DESCRIPTION

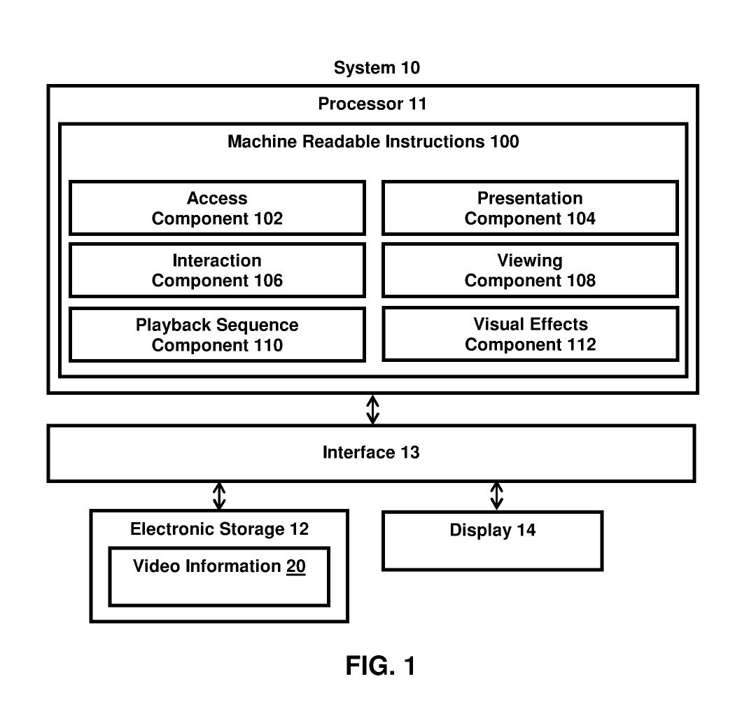

FIG. 1 illustrates a system 10 for generating custom views of videos. The system 10 may include one or more of a processor 11, an electronic storage 12, an interface 13 (e.g., bus, wireless interface), a display 14, and/or other components. Video information 20 defining spherical video content may be accessed by the processor 11. The spherical video content may have a progress length. The spherical video content may define visual content viewable from a point of view as a function of progress through the spherical video content. The spherical video content may be presented on the display 14. Interaction information may be received during the presentation of the spherical content on the display 14. The interaction information may indicate a user's viewing selections of the spherical video content. The user's viewing selections may include viewing directions for the spherical video content selected by the user as the function of progress through the spherical video content. Display field of view may be determined based on the viewing directions. The display fields of view may define extents of the visual content viewable from the point of view as the function of progress through the spherical video content.

User input to record a custom view of the spherical video content may be received. Responsive to receiving the user input to record the custom view of the spherical video content, a playback sequence for the spherical video content may be generated based on at least a portion of the interaction information. A playback sequence may identify one or more of (1) different points in the progress length to be displayed during playback, (2) an order in which the identified points are displayed during playback, (3) the extents of the visual content to be displayed at the identified points, and/or other information about how the spherical video content is to be displayed during playback. The playback sequence may mirror at least a portion of the presentation of the spherical video content on the display 14. A playback sequence may include one or more files containing descriptions/instructions regarding how to present the spherical video content during a subsequent playback such that the subsequent presentation mirrors at least a portion of the presentation of the spherical video content on the display. A playback sequence may include one or more video content that mirrors at least a portion of the spherical visual content presented on the display.

The electronic storage 12 may be configured to include electronic storage medium that electronically stores information. The electronic storage 12 may store software algorithms, information determined by the processor 11, information received remotely, and/or other information that enables the system 10 to function properly. For example, the electronic storage 12 may store information relating to video information, video content, interaction information, a user's viewing selections, display fields of view, custom view of video content, playback sequence, and/or other information.

The electronic storage 12 may store video information 20 defining one or more video content. Video content may refer to media content that may be consumed as one or more videos. Video content may include one or more videos stored in one or more formats/container, and/or other video content. A video may include a video clip captured by a video capture device, multiple video clips captured by a video capture device, and/or multiple video clips captured by separate video capture devices. A video may include multiple video clips captured at the same time and/or multiple video clips captured at different times. A video may include a video clip processed by a video application, multiple video clips processed by a video application and/or multiple video clips processed by separate video applications.

Video content may have a progress length. A progress length may be defined in terms of time durations and/or frame numbers. For example, video content may include a video having a time duration of 60 seconds. Video content may include a video having 1800 video frames. Video content having 1800 video frames may have a play time duration of 60 seconds when viewed at 30 frames/second. Other time durations and frame numbers are contemplated.

Video content may define visual content viewable as a function of progress through the video content. In some implementations, video content may include one or more of spherical video content, virtual reality content, and/or other video content. Spherical video content and/or virtual reality content may define visual content viewable from one or more points of view as a function of progress through the spherical/virtual reality video content.

Spherical video content may refer to a video capture of multiple views from a single location. Spherical video content may include a full spherical video capture (360 degrees of capture) or a partial spherical video capture (less than 360 degrees of capture). Spherical video content may be captured through the use of one or more cameras/image sensors to capture images/videos from a location. The captured images/videos may be stitched together to form the spherical video content.

Virtual reality content may refer to content that may be consumed via virtual reality experience. Virtual reality content may associate different directions within the virtual reality content with different viewing directions, and a user may view a particular directions within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical video content and/or virtual reality content may have been captured at one or more locations. For example, spherical video content and/or virtual reality content may have been captured from a stationary position (e.g., a seat in a stadium). Spherical video content and/or virtual reality content may have been captured from a moving position (e.g., a moving bike). Spherical video content and/or virtual reality content may include video capture from a path taken by the capturing device(s) in the moving position. For example, spherical video content and/or virtual reality content may include video capture from a person walking around in a music festival.

The display 14 may be configured to present video content and/or other information. In some implementations, the display 14 may include a touchscreen display configured to receive user input indicating the user's viewing selections of the video content. For example, the display 14 may include a touchscreen display of a mobile device (e.g., camera, smartphone, tablet, laptop). The touchscreen display may generate output signals indicating a location of the user's engagements with the touchscreen display.

A touchscreen display may include a touch-sensitive screen and/or other components. A user may engage with the touchscreen display by touching one or more portions of the touch-sensitive screen (e.g., with one or more fingers, stylus). A user may engage with the touchscreen display at a moment in time, at multiple moments in time, during a period, or during multiple periods. For example, a user may tap on the touchscreen display to interact with video content presented the display 14 and/or to interact with an application for presenting video content. A user may pinch or unpinch the touchscreen display to effectuate change in zoom/magnification for presentation of the video content. A user may make a twisting motion (e.g., twisting two figures on the touchscreen display, holding one finger in position on the touchscreen display while twisting another figure on the touchscreen display) to effectuate visual rotation of the video content (e.g., warping visuals within the video content, changing viewing rotation). Other types of engagement of the touchscreen display by users are contemplated.

In some implementations, the display 14 may include one or more motion sensors configured to generate output signals conveying motion information related to a motion of the display 14. In some implementations, a motion sensor may include one or more of an accelerometer, a gyroscope, a magnetometer, an inertial measurement unit, a magnetic position sensor, a radio-frequency position sensor, and/or other motion sensors.

Motion information may define one or more motions, positions, and/or orientations of the motion sensor/object monitored by the motion sensor (e.g., the display 14). Motion of the display 14 may include one or more of position of the display 14, orientation (e.g., yaw, pitch, roll) of the display 14, changes in position and/or orientation of the display 14, and/or other motion of the image sensor 14 at a time or over a period of time, and/or at a location or over a range of locations. For example, the display 14 may include a display of a smartphone held by a user, and the motion information may define the motion/position/orientation of the smartphone. The motion of the smartphone may include a position and/or an orientation of the smartphone, and the user's viewing selections of the video content may be determined based on the position and/or the orientation of the smartphone.

Referring to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine readable instructions 100 to facilitate generating custom views of videos. The machine readable instructions 100 may include one or more computer program components. The machine readable instructions 100 may include one or more of an access component 102, a presentation component 104, an interaction component 106, a viewing component 108, a playback sequence component 110, and/or other computer program components. In some implementations, the machine readable instructions 100 may include a visual effects component 112.

The access component 102 may be configured to access video information defining one or more video content and/or other information. The access component 102 may access video information from one or more storage locations. A storage location may include electronic storage 12, electronic storage of one or more image sensors (not shown in FIG. 1), electronic storage of a device accessible via a network, and/or other locations. For example, the access component 102 may access the video information 20 stored in the electronic storage 12. The access component 102 may be configured to access video information defining one or more video content during acquisition of the video information and/or after acquisition of the video information by one or more image sensors. For example, the access component 102 may access video information defining video while the video is being captured by one or more image sensors. The access component 102 may access video information defining a video after the video has been captured and stored in memory (e.g., the electronic storage 12).

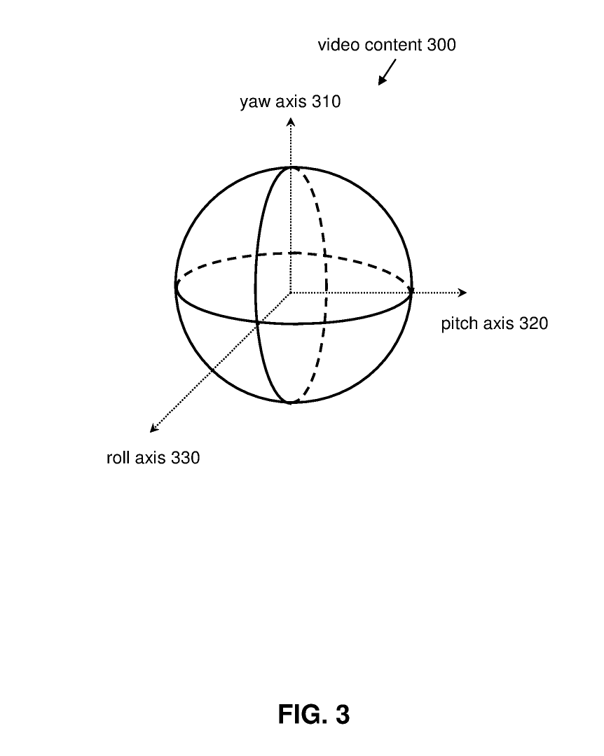

FIG. 3 illustrates an example video content 300 defined by video information. The video content 300 may include spherical video content. In some implementations, spherical video content may be stored with a 5.2K resolution. Using a 5.2K spherical video content may enable viewing windows for the spherical video content with resolution close to 1080p. FIG. 3 illustrates example rotational axes for the video content 300. Rotational axes for the video content 300 may include a yaw axis 310, a pitch axis 320, a roll axis 330, and/or other axes. Rotations about one or more of the yaw axis 310, the pitch axis 320, the roll axis 330, and/or other axes may define viewing directions/display fields of view for the video content 300.

) For example, a 0-degree rotation of the video content 300 around the yaw axis 310 may correspond to a front viewing direction. A 90-degree rotation of the video content 300 around the yaw axis 310 may correspond to a right viewing direction. A 180-degree rotation of the video content 300 around the yaw axis 310 may correspond to a back viewing direction. A −90-degree rotation of the video content 300 around the yaw axis 310 may correspond to a left viewing direction.

A 0-degree rotation of the video content 300 around the pitch axis 320 may correspond to a viewing direction that is level with respect to horizon. A 45-degree rotation of the video content 300 around the pitch axis 320 may correspond to a viewing direction that is pitched up with respect to horizon by 45-degrees. A 90 degree rotation of the video content 300 around the pitch axis 320 may correspond to a viewing direction that is pitched up with respect to horizon by 90-degrees (looking up). A −45-degree rotation of the video content 300 around the pitch axis 320 may correspond to a viewing direction that is pitched down with respect to horizon by 45-degrees. A −90 degree rotation of the video content 300 around the pitch axis 320 may correspond to a viewing direction that is pitched down with respect to horizon by 90-degrees (looking down).

A 0-degree rotation of the video content 300 around the roll axis 330 may correspond to a viewing direction that is upright. A 90 degree rotation of the video content 300 around the roll axis 330 may correspond to a viewing direction that is rotated to the right by 90 degrees. A −90-degree rotation of the video content 300 around the roll axis 330 may correspond to a viewing direction that is rotated to the left by 90-degrees. Other rotations and viewing directions are contemplated.

The presentation component 104 may be configured to effectuate presentation of video content on the display 14. For example, the presentation component 104 may effectuate presentation of spherical video content on the display 14. Presentation of the video content on the display 14 may include presentation of the video content based on display fields of view. The display fields of view may define viewable extents of visual content within the video content. The display fields of view may be determined based on the viewing directions and/or other information. In some implementations, the display fields of view may be further determined based on the viewing zooms.

In some implementations, the presentation component 104 may be configured to effectuate presentation of one or more user interfaces on the display 14. A user interface may include a record field and/or other fields. In some implementations, the record field may visually resemble a “record” button on a mobile device. For example, the record field may have the same/similar visual appearance as a record button of a camera application on a smartphone. The record field may be circular and/or include the color red. Other appearance of the record field are contemplated. The user interface may enable a user's interaction with the video content/application presenting the video content on the display 14. A user may interact with the video content/application presenting the video content via other methods (e.g., interacting with a virtual and/or a physical button on a mobile device).

The interaction component 106 may be configured to receive interaction information during the presentation of video content on the display 14. For example, the interaction component 106 may receive interaction information during the presentation of spherical video content on the display 14. The interaction information may indicate how a user interacted with video content/display 14 to view the video content.

The interaction information may indicate a user's viewing selections of the video content and/or other information. The user's viewing selections may be determined based on the user input received via a touchscreen display. The user's viewing selections may be determined based on motion of the display 14. The user's viewing selections may include viewing directions for the video content selected by the user as the function of progress through the video content, and/or other information. Viewing directions for the video content may correspond to orientations of the display fields of view selected by the user. In some implementations, viewing directions for the video content may be characterized by rotations around the yaw axis 310, the pitch axis 320, the roll axis 330, and/or other axes. Viewing directions for the video content may include the directions in which the user desires to view the video content.

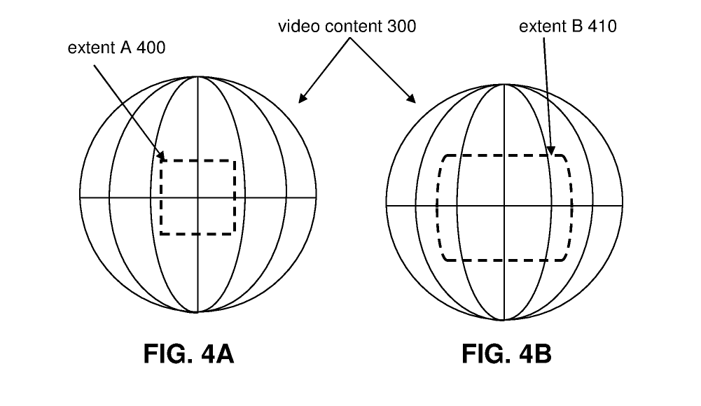

In some implementations, the user's viewing selections may include viewing zooms for the video content selected by the user as the function of progress through the video content. Viewing zooms for the video content may correspond to a size of the viewable extents of visual content within the video content. For example, FIGS. 4A-4B illustrate examples of extents for video content 300. In FIG. 4A, the size of the viewable extent of the video content 300 may correspond to the size of extent A 400. In FIG. 4B, the size of viewable extent of the video content 300 may correspond to the size of extent B 410. Viewable extent of the video content 300 in FIG. 4A may be smaller than viewable extent of the video content 300 in FIG. 4B.

In some implementations, the user's viewing selections may include visual effects for the video content selected by the user as the function of progress through the video content. A visual effect may refer to a change in presentation of the video content on the display 14. A visual effect may change the presentation of the video content for a video frame, for multiple frames, for a point in time, and/or for a duration of time. In some implementations, a visual effect may include one or more changes in perceived speed at which the video content is presented during playback. In some implementations, a visual effect may include one or more visual transformation of the video content. In some implementations, the visual effects may include a change in a projection for the video content and/or other visual effects. In some implementations, the visual effects may include one or more preset changes in the video content and/or other visual effects.

A user's viewing selections of the video content may remain the same or change as a function of progress through the video content. For example, a user may view the video content without changing the viewing direction (e.g., a user may view a “default view” of video content captured at a music festival, etc.). A user may view the video content by changing the directions of view (e.g., a user may change the viewing direction of video content captured at a music festival to follow a particular band, etc.). Other changes in a user's viewing selections of the video content are contemplated.

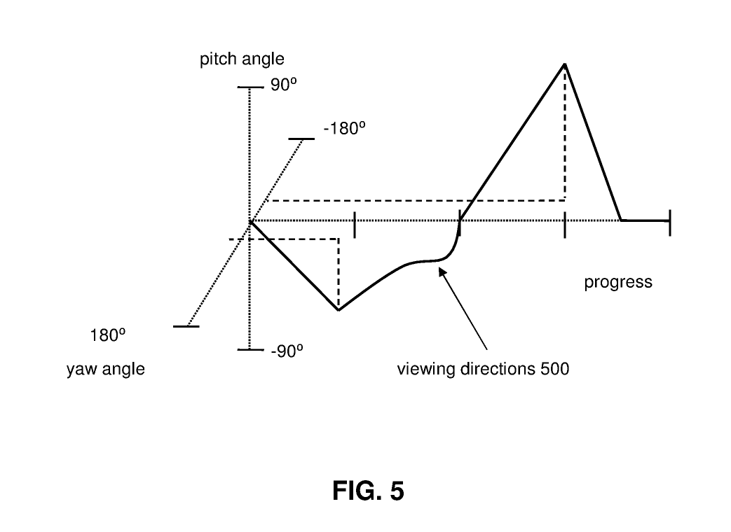

For example, FIG. 5 illustrates an exemplary viewing directions 500 selected by a user for video content as a function of progress through the video content. The viewing directions 500 may change as a function of progress through the video content. For example, at 0% progress mark, the viewing directions 500 may correspond to a zero-degree yaw angle and a zero-degree pitch angle. At 25% progress mark, the viewing directions 500 may correspond to a positive yaw angle and a negative pitch angle. At 50% progress mark, the viewing directions 500 may correspond to a zero-degree yaw angle and a zero-degree pitch angle. At 75% progress mark, the viewing directions 500 may correspond to a negative yaw angle and a positive pitch angle. At 87.5% progress mark, the viewing directions 500 may correspond to a zero-degree yaw angle and a zero-degree pitch angle. Other selections of viewing directions/selections are contemplated.

In some implementations, the interaction information may be determined based on the location of the user's engagements with the touchscreen display, and/or other information. For example, a user may touch the touchscreen display to interact with video content presented the display 14 and/or to interact with an application for presenting video content. A user may interact with the touchscreen display to pan the viewing direction (e.g., via dragging/tapping a finger on the touchscreen display, via interacting with options to change the viewing direction), to change the zoom (e.g., via pinching/unpinching the touchscreen display, via interacting with options to change the viewing zoom), to apply one or more visual effects (e.g., via making preset movements corresponding to visual effects on the touchscreen display, via interacting with options to apply visual effects), and/or provide other interaction information. Other interactions with the touchscreen display are contemplated.

In some implementations, the interaction information may be determined based on the motion of the display 14, and/or other information. For example, the interaction information may be determined based on one or more motions, positions, and/or orientation of the display 14 (e.g., as detected by one or more motion sensors). For example, the display 14 may include a display of a smartphone held by a user, and the interaction information may be determined based on the motion/position/orientation of the smartphone. A user's viewing selections may be determined based on the motion/position/orientation of the smartphone. Viewing directions for the video content selected by the user may be determined based on the motion/position/orientation of the smartphone. For example, based on the user tilting the smartphone upwards, the viewing directions for the video content may tilt upwards.

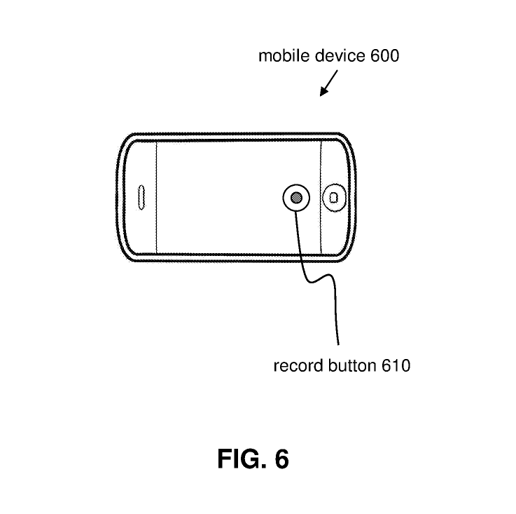

The interaction component 106 may be configured to receive user input to record a custom view of the video content. For example, the interaction component 106 may receive user input to record a custom view of spherical video content. In some implementations, the user input to record the custom view of the video content may be received based on the user's interaction with the record field within the user interface. FIG. 6 illustrates an example mobile device 600 for generating custom views of videos. As shown in FIG. 6, the mobile device 600 may present on a display a user interface including a record button 610. The record button 610 may correspond to the record field by which a user may provide user input to record a custom view of the video content. The record button 610 have the same/similar visual appearance as a record button of a camera application. The record button 610 may be circular and/or include the color red. Other appearance of the record button 610 are contemplated.

The viewing component 108 may be configured to determine display fields of view based on the viewing directions and/or other information. The display fields of view may define viewable extents of visual content within the video content (e.g., extent A 400 shown in FIG. 4A, extent B 410 shown in FIG. 4B). In some implementations, the display fields of view may be further determined based on the viewing zooms and/or other information. For example, the display fields of view may be further determined based on a user pinching or unpinching a touchscreen display to effectuate change in zoom/magnification for presentation of the video content.

For example, based on an orientation of a mobile device presenting the video content, the viewing directions may be determined (e.g., the viewing directions 500 shown in FIG. 5) and the display fields of view may be determined based on the viewing directions. The display fields of view may change based on changes in the viewing directions (based on changes in the orientation of the mobile device), based on changes in the viewing zooms, and/or other information. For example, a user of a mobile device may be viewing video content while holding the mobile device in a landscape orientation. The display field of view may define a landscape viewable extent of the visual content within the video content. During the presentation of the video content, the user may switch the orientation of the mobile device to a portrait orientation. The display field of view may change to define a portrait viewable extent of the visual content within the video content.

For spherical video content, the display fields of view may define extents of the visual content viewable from a point of view as the function of progress through the spherical video content. For example, the display fields of view may define a first extent of the visual content at a first point in the progress length and a second extent of the visual content at a second point in the progress length. The presentation of the spherical video content on the display 14 may include presentation of the extents of the visual content on the display 14 at different points in the progress length such that the presentation of the spherical video content on the display 14 includes presentation of the first extent at the first point prior to presentation of the second extent at the second point.

For example, the viewing component 108 may determine display fields of view based on an orientation of a mobile device presenting the spherical video content. Determining the display fields of view may include determining a viewing angle in the spherical video content that corresponds to the orientation of the mobile device. The viewing component 108 may determine display field of view based on the orientation of the mobile device and/or other information. For example, the display field of view may include a particular horizontal field of view (e.g., left, right) based on the mobile device being rotated left and right. The display field of view may include a particular vertical field of view (e.g., up, down) based on the mobile device being rotated up and down. Other display fields of view are contemplated.

The visual effects component 112 may be configured to apply one or more visual effects to the video content. A visual effect may refer to a change in presentation of the video content on the display 14. For example, a visual effect may include application of one or more lens curve to the video content. A visual effect may change the presentation of the video content for a video frame (e.g., a non-spherical frame, a spherical frame, a frame of spherical video content generated by stitching multiple non-spherical frames), for multiple frames, for a point in time, and/or for a duration of time. In some implementations, a visual effect may include one or more changes in perceived speed at which the video content is presented during playback. In some implementations, a visual effect may include one or more visual transformation of the video content. In some implementations, a visual effect may apply one or more filters to the video content (e.g., smoothing filter, color filter). In some implementations, a visual effect may simulate the use of a stabilization tool (e.g., gimbal) while recording the video content. In some implementations, the visual effects may include a change in a projection for the video content and/or other visual effects. In some implementations, the visual effects component 112 may select one or more visual effects randomly from a list of visual effects.

In some implementations, the visual effects may include one or more preset changes in the video content and/or other visual effects. For example, the visual effects may be applied via a user interaction with a toolkit listing available preset visual effects. Preset visual effects may refer to visual effects with one or more predefined criteria that facilitates selection and application of visual effects by a user. For example, a preset visual effect may include a swing effect, which effectuates changes in the viewing direction and/or a viewing zoom for the video content. For example, the video content may include a spherical capture of a scene. The viewing direction selected by a user may show a video capture of an exciting scene (e.g., a particular trick on a skateboard, an appearance of a whale in the sea). A user may select the swing effect to automatically change the viewing direction and/or a viewing zoom to be focused on persons captured within the video content. The amount of change in the viewing direction/zoom may be determined based on a default, a user input (e.g., specifying a particular change in the viewing direction/zoom), selection of a particular preset range, detection algorithm (e.g., detecting faces in the video content), and/or other information. As another example, a preset visual effect may include a change in the field of view—changes between a third person view or a first person view and/or a change in the viewing projection. Other types of preset visual effects are contemplated.

In some implementations, the visual effects component 112 may select one or more visual effects based on a user selection. For example, the visual effects component 112 may apply one or more lighting/saturation effects based on a user's selection of the lighting/saturation effect(s) (e.g., from a user interface). The visual effects component 112 may apply one or more visual rotations (e.g., warping visuals within the video content, changing viewing rotation) based on a user making a twisting motion on a touchscreen display. Other applications of visual effects are contemplated.

The playback sequence component 110 may be configured to generate one or more playback sequences for the video content based on at least a portion of the interaction information and/or other information. The playback sequence component 110 may generate one or more playback sequences responsive to reception of the user input to record the custom view of the video content. For example, the playback sequence component 110 may generate one or more playback sequences responsive to reception of a user's interaction with the record button 610 (shown in FIG. 6).

A playback sequence may include one or more files containing descriptions/instructions regarding how to present the video content during a subsequent playback such that the subsequent presentation mirrors at least a portion of the presentation of the video content on the display 14. A playback sequence may include one or more video content that mirrors at least a portion of the visual content presented on the display 14.

A playback sequence may mirroring at least a portion of the presentation of the video content on the display such that the playback sequence identifies one or more of: (1) at least some of the different points in the progress length to be displayed during playback—some of the different points may include the first point and the second point; (2) an order in which the identified points are displayed during playback—the order may include presentation of the first point prior to presentation of the second point; (3) the extents of the visual content to be displayed at the identified points during playback—the extents may include the first extent at the first point and the second extent at the second point, and/or other information about how the video content is to be displayed during playback.

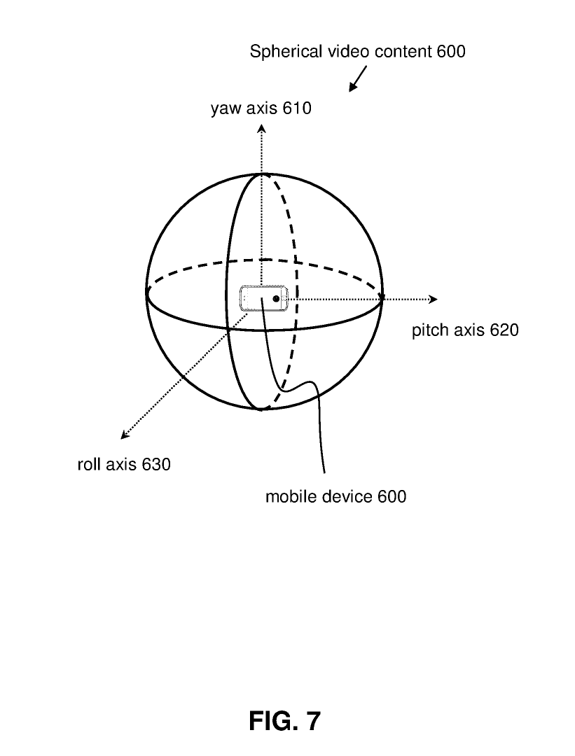

For example, responsive to a user's interaction with the record button 610, the playback sequence component 110 may mirror the presentation of the video content on the display of the mobile device 600 following the moment at which the user interacted with the record button. Such generation of playback sequences may simulate recording of video content using the mobile device 600. For example, the video content accessed and presented on a display of the mobile device 600 may include spherical video content 600 (shown in FIG. 7). Using the mobile device 600, a user may change the extent of the spherical video content 600 presented on the display of the mobile device 600 (e.g., via rotation about the yaw axis 610, pitch axis 620, roll axis 630). The user may record the views presented on the display as if the user were recording a part of the scene captured in the spherical video content 600—the user's generation of the playback sequence may simulate the user capturing video content as if the user were present the scene at which the spherical video content 600 was captured.

The playback sequence may mirror the playback of the video content presented on the display 14. For example, using the mobile device 600, a user may play, pause, fast forward, rewind, skip and/or otherwise determine the playback of the spherical video content 600. In some implementations, the playback sequence may mirror the playback of the spherical video content 600 on the display of the mobile device as manipulated by the user—e.g., the user pausing the playback of the spherical video content 600 for five seconds at a particular frame may result in the playback sequence presenting the particular frame for five seconds, the user fast forwarding (e.g., at 2× speed) the playback of the spherical video content 600 for a duration of time may result in the playback sequence presenting the frames corresponding to the duration of time at a faster perceived speed (e.g., at 2× speed).

In some implementations, the playback sequence may mirror the playback of the spherical video content 600 on the display of the mobile device while skipping one or more manipulations of the playback by the user. For example, a user may interact with the mobile device 600 to play, pause, fast forward, rewind, skip and/or otherwise determine the playback of the spherical video content so that there are discontinuities in the playback of the spherical video content. The playback sequence may skip one or more manipulations such that one or more discontinuities in the playback are not present in the playback sequence—e.g., the user pausing the playback of the spherical video content 600 for five seconds at a particular frame (e.g., to apply a visual effect) or fast forwarding the playback of the spherical video content 600 from a first point to the second point in the progress length may not be mirrored in the playback sequence such that the playback sequence does not present the particular frame for five seconds or display the fast forwarding of the spherical video content 600 (e.g., the playback sequence may skip from the first point to the second point in the progress length).

In some implementations, the playback sequence may include audio from the video content and/or audio from another source. For example, the playback sequence may include audio from the video content overlaid with another audio track (e.g., musical selected by a user to be played as an accompaniment for the video content, words spoken by the user and recorded by a microphone of the mobile device 600 after the user interacted with the record button 610). The volume of the audio in the playback sequence (e.g., audio from the spherical video content 600 and/or audio added to the playback sequence) may be adjusted by the user.

In some implementations, generating a playback sequence for video content may include generating one or more files containing descriptions to change the presentation of the video content based on least the portion of the interaction information. For example, a playback sequence may be generated as a director track that includes information as to how the video content was presented on the display 14. Generating a director track may enable the creation of the playback sequence without encoding separate video content. The director track may be used to generate the mirrored video content on the fly. For example, video content may be stored on a server and different director tracks may be stored on individual mobile devices and/or at the server. A user wishing to view a particular director track may provide the director track to the server and/or select the director track stored at the server. The video content may be presented during playback based on the director track. In some implementations, video content may be stored on a client device (e.g., mobile device). A user may access different director tracks to view different version of the video content without encoding separate video content. Other uses of director tracks are contemplated.

In some implementations, generating a playback sequence for video content may include encoding one or more video content based on at least the portion of the interaction information. For example, generating a playback sequence for spherical video content may include encoding one or more non-spherical video content based on at least the portion of the interaction information. The non-spherical video content may mirror at least the portion of the presentation of the spherical video content on the display 14. The non-spherical video content may provide a non-spherical (e.g., two-dimensional) view of the spherical video content presented (and “recorded”) on the display 14. In some implementations, one or more videos may be encoded during and/or after the presentation of the video content on the display 14.

While the description herein may be directed to video content, one or more other implementations of the system/method described herein may be configured for other types media content. Other types of media content may include one or more of audio content (e.g., music, podcasts, audio books, and/or other audio content), multimedia presentations, images, slideshows, visual content (one or more images and/or videos), and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although the processor 11 and the electronic storage 12 are shown to be connected to the interface 13 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components.

While computer program components are described herein as being implemented via processor 11 through machine readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components 102, 104, 106, 108, 110, and/or 112 may be eliminated, and some or all of its functionality may be provided by other computer program components. As another example, processor 11 may be configured to execute one or more additional computer program components that may perform some or all of the functionality attributed to one or more of computer program components 102, 104, 106, 108, 110, and/or 112 described herein.

The electronic storage media of the electronic storage 12 may be provided integrally (i.e., substantially non-removable) with one or more components of the system 10 and/or removable storage that is connectable to one or more components of the system 10 via, for example, a port (e.g., a USB port, a Firewire port, etc.) or a drive (e.g., a disk drive, etc.). The electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 12 may be a separate component within the system 10, or the electronic storage 12 may be provided integrally with one or more other components of the system 10 (e.g., the processor 11). Although the electronic storage 12 is shown in FIG. 1 as a single entity, this is for illustrative purposes only. In some implementations, the electronic storage 12 may comprise a plurality of storage units. These storage units may be physically located within the same device, or the electronic storage 12 may represent storage functionality of a plurality of devices operating in coordination.

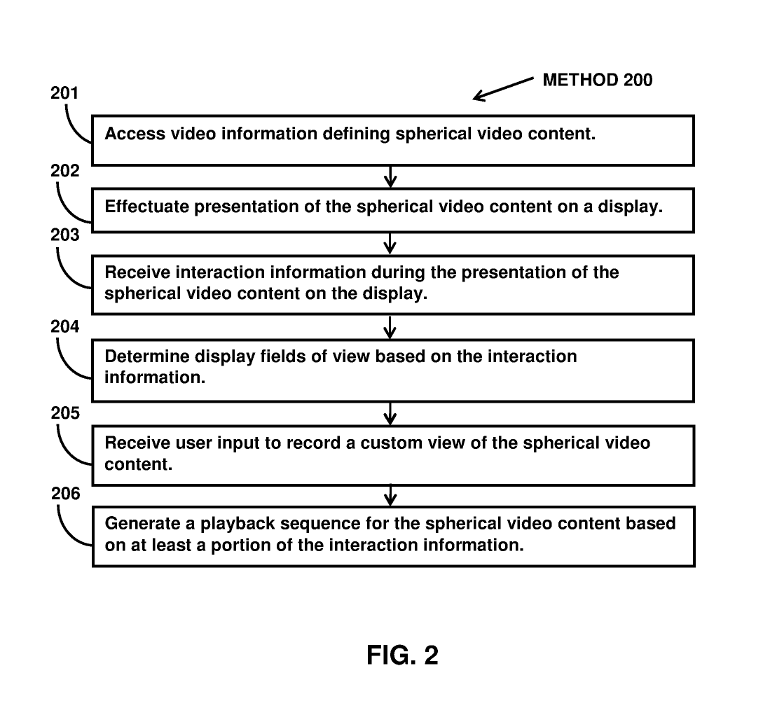

FIG. 2 illustrates method 200 for generating custom views of videos. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, video information defining spherical video content may be accessed. The spherical video content having a progress length. The spherical video content may define visual content viewable from a point of view as a function of progress through the spherical video content. The video information may be stored in physical storage media. In some implementation, operation 201 may be performed by a processor component the same as or similar to the access component 102 (Shown in FIG. 1 and described herein).

At operation 202, presentation of the spherical video content on a display may be effectuated. In some implementations, operation 202 may be performed by a processor component the same as or similar to the presentation component 104 (Shown in FIG. 1 and described herein).

At operation 203, interaction information may be received during the presentation of the spherical video content on the display. The interaction information may indicate a user's viewing selections of the spherical video content. The user's viewing selections may include viewing directions for the spherical video content selected by the user as the function of progress through the spherical video content. In some implementations, operation 203 may be performed by a processor component the same as or similar to the interaction component 106 (Shown in FIG. 1 and described herein).

At operation 204, display fields of view may be determined based on the interaction information (e.g., the viewing directions). The display fields of view may define extents of the visual content viewable from the point of view as the function of progress through the spherical video content. The display fields of view may define a first extent of the visual content at a first point in the progress length and a second extent of the visual content at a second point in the progress length. The presentation of the spherical video content on the display may include presentation of the extents of the visual content on the display at different points in the progress length such that the presentation of the spherical video content on the display includes presentation of the first extent at the first point prior to presentation of the second extent at the second point. In some implementations, operation 204 may be performed by a processor component the same as or similar to the viewing component 108 (Shown in FIG. 1 and described herein).

At operation 205, user input to record a custom view of the spherical video content may be received. In some implementations, operation 205 may be performed by a processor component the same as or similar to the interaction component 106 (Shown in FIG. 1 and described herein).

At operation 206, responsive to receiving the user input to record the custom view of the spherical video content, a playback sequence for the spherical video content may be generated based on at least a portion of the interaction information. The playback sequence may mirror at least a portion of the presentation of the spherical video content on the display such that the playback sequence identifies: (1) at least some of the different points in the progress length to be displayed during playback, the some of the different points including the first point and the second point; (2) an order in which the identified points are displayed during playback, the order including presentation of the first point prior to presentation of the second point, and (3) the extents of the visual content to be displayed at the identified points during playback, the extents including the first extent at the first point and the second extent at the second point. In some implementations, operation 206 may be performed by a processor component the same as or similar to the playback sequence component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for generating custom views of videos, the system comprising:
a display configured to present video content; and
one or more physical processors configured by machine-readable instructions to:
access video information defining spherical video content, the spherical video content having a progress length, the spherical video content defining visual content viewable from a point of view as a function of progress through the spherical video content;
effectuate presentation of the spherical video content on the display;
receive interaction information during the presentation of the spherical video content on the display, the interaction information indicating a user's viewing selections of the spherical video content, the user's viewing selections including viewing directions for the spherical video content selected by the user as the function of progress through the spherical video content;
determine display fields of view based on the viewing directions, the display fields of view defining extents of the visual content viewable from the point of view as the function of progress through the spherical video content, the display fields of view defining a first extent of the visual content at a first point in the progress length and a second extent of the visual content at a second point in the progress length, wherein the presentation of the spherical video content on the display includes presentation of the extents of the visual content on the display at different points in the progress length such that the presentation of the spherical video content on the display includes presentation of the first extent at the first point prior to presentation of the second extent at the second point;
receive user input to record a custom view of the spherical video content; and
responsive to receiving the user input to record the custom view of the spherical video content, generate a playback sequence for the spherical video content based on at least a portion of the interaction information, the playback sequence mirroring at least a portion of the presentation of the spherical video content on the display such that the playback sequence identifies:
at least some of the different points in the progress length to be displayed during playback, the some of the different points including the first point and the second point,
an order in which the identified points are displayed during playback, the order including presentation of the first point prior to presentation of the second point, and
the extents of the visual content to be displayed at the identified points during playback, the extents including the first extent at the first point and the second extent at the second point.

2. The system of claim 1, wherein:
the one or more physical processors are further configured by the machine-readable instructions to effectuate presentation of a user interface on the display, the user interface including a record field; and
the user input to record the custom view of the spherical video content is received based on the user's interaction with the record field.

3. The system of claim 1, wherein the display includes a touchscreen display configured to receive user input indicating the user's viewing selections of the spherical video content, the touchscreen display generating output signals indicating a location of the user's engagements with the touchscreen display, and the interaction information determined based on the location of the user's engagements with the touchscreen display.

4. The system of claim 1, wherein the display includes a motion sensor configured to generate output signals conveying motion information related to a motion of the display, and the interaction information determined based on the motion of the display.

5. The system of claim 4, wherein the motion of the display includes an orientation of the display, and the user's viewing selections of the spherical video content are determined based on the orientation of the display.

6. The system of claim 1, wherein the user's viewing selections further include viewing zooms for the spherical video content selected by the user as the function of progress through the spherical video content, and the display fields of view are further determined based on the viewing zooms.

7. The system of claim 1, wherein the user's viewing selections further include visual effects for the spherical video content selected by the user as the function of progress through the spherical video content, and the one or more physical processors are further configured by the machine-readable instructions to apply the visual effects to the spherical video content.

8. The system of claim 7, wherein the visual effects include a change in a projection for the spherical video content.

9. The system of claim 1, wherein generating the playback sequence for the spherical video content includes encoding a non-spherical video content based on at least the portion of the interaction information, the non-spherical video content mirroring at least the portion of the presentation of the spherical video content on the display.

10. A method for generating custom views of videos, the method comprising:
accessing video information defining spherical video content, the spherical video content having a progress length, the spherical video content defining visual content viewable from a point of view as a function of progress through the spherical video content;
effectuating presentation of the spherical video content on a display configured to present video content;
receiving interaction information during the presentation of the spherical video content on the display, the interaction information indicating a user's viewing selections of the spherical video content, the user's viewing selections including viewing directions for the spherical video content selected by the user as the function of progress through the spherical video content;
determining display fields of view based on the viewing directions, the display fields of view defining extents of the visual content viewable from the point of view as the function of progress through the spherical video content, the display fields of view defining a first extent of the visual content at a first point in the progress length and a second extent of the visual content at a second point in the progress length, wherein the presentation of the spherical video content on the display includes presentation of the extents of the visual content on the display at different points in the progress length such that the presentation of the spherical video content on the display includes presentation of the first extent at the first point prior to presentation of the second extent at the second point;
receiving user input to record a custom view of the spherical video content; and
responsive to receiving the user input to record the custom view of the spherical video content, generating a playback sequence for the spherical video content based on at least a portion of the interaction information, the playback sequence mirroring at least a portion of the presentation of the spherical video content on the display such that the playback sequence identifies:
at least some of the different points in the progress length to be displayed during playback, the some of the different points including the first point and the second point,
an order in which the identified points are displayed during playback, the order including presentation of the first point prior to presentation of the second point, and
the extents of the visual content to be displayed at the identified points during playback, the extents including the first extent at the first point and the second extent at the second point.

11. The method of claim 10, further comprising effectuating presentation of a user interface on the display, the user interface including a record field, wherein the user input to record the custom view of the spherical video content is received based on the user's interaction with the record field.

12. The method of claim 10, wherein the display includes a touchscreen display configured to receive user input indicating the user's viewing selections of the spherical video content, the touchscreen display generating output signals indicating a location of the user's engagements with the touchscreen display, and the interaction information determined based on the location of the user's engagements with the touchscreen display.

13. The method of claim 10, wherein the display includes a motion sensor configured to generate output signals conveying motion information related to a motion of the display, and the interaction information determined based on the motion of the display.

14. The method of claim 13, wherein the motion of the display includes an orientation of the display, and the user's viewing selections of the spherical video content are determined based on the orientation of the display.

15. The method of claim 10, wherein the user's viewing selections further include viewing zooms for the spherical video content selected by the user as the function of progress through the spherical video content, and the display fields of view are further determined based on the viewing zooms.

16. The method of claim 10, further comprising applying visual effects to the spherical video content, wherein the user's viewing selections further include the visual effects for the spherical video content selected by the user as the function of progress through the spherical video content.

17. The method of claim 16, wherein the visual effects include a change in a projection for the spherical video content.

18. The method of claim 10, wherein generating the playback sequence for the spherical video content includes encoding a non-spherical video content based on at least the portion of the interaction information, the non-spherical video content mirroring at least the portion of the presentation of the spherical video content on the display.

19. A system for generating custom views of videos, the system comprising:
a touchscreen display configured to present video content and receive user input indicating a user's viewing selections of spherical video content, the touchscreen display generating output signals indicating a location of the user's engagements with the touchscreen display; and
one or more physical processors configured by machine-readable instructions to:
access video information defining the spherical video content, the spherical video content having a progress length, the spherical video content defining visual content viewable from a point of view as a function of progress through the spherical video content;
effectuate presentation of the spherical video content on the touchscreen display;
effectuate presentation of a user interface on the touchscreen display, the user interface including a record field;
receive interaction information during the presentation of the spherical video content on the touchscreen display, the interaction information indicating the user's viewing selections of the spherical video content, the user's viewing selections including viewing directions for the spherical video content selected by the user as the function of progress through the spherical video content;
determine display fields of view based on the viewing directions, the display fields of view defining extents of the visual content viewable from the point of view as the function of progress through the spherical video content, the display fields of view defining a first extent of the visual content at a first point in the progress length and a second extent of the visual content at a second point in the progress length, wherein the presentation of the spherical video content on the touchscreen display includes presentation of the extents of the visual content on the touchscreen display at different points in the progress length such that the presentation of the spherical video content on the touchscreen display includes presentation of the first extent at the first point prior to presentation of the second extent at the second point;
receive user input to record a custom view of the spherical video content based on the user's interaction with the record field; and
responsive to receiving the user input to record the custom view of the spherical video content, generate a playback sequence for the spherical video content based on at least a portion of the interaction information, the playback sequence mirroring at least a portion of the presentation of the spherical video content on the touchscreen display such that the playback sequence identifies:
at least some of the different points in the progress length to be displayed during playback, the some of the different points including the first point and the second point,
an order in which the identified points are displayed during playback, the order including presentation of the first point prior to presentation of the second point, and
the extents of the visual content to be displayed at the identified points during playback, the extents including the first extent at the first point and the second extent at the second point.

20. The system of claim 19, wherein the touchscreen display includes a motion sensor configured to generate output signals conveying motion information related to a motion of the touchscreen display, and the interaction information determined based on the motion of the touchscreen display, motion of the touchscreen display including an orientation of the touchscreen display such that the user's viewing selections of the spherical video content are determined based on the orientation of the touchscreen display.
